(19) United States
(12) Patent Application Publication
(10) Pub. No.: US 2017/0135339 A1
(43) Pub. Date: May 18, 2017

(54) COATING FORMULATION FOR SEED AND SURFACE STERILIZATION

(71) Applicant: YEDITEPE UNIVERSITESI, Istanbul (TR)

(72) Inventors: Fikrettin SAHIN, Istanbul (TR); Zeynep USTAOGLU, Istanbul (TR); Okan DEMIR, Istanbul (TR)

(73) Assignee: YEDITEPE UNIVERSITESI, Istanbul (TR)

(21) Appl. No.: 15/322,125

(22) PCT Filed: Feb. 10, 2016
(86) PCT No.: PCT/TR2016/050035

§ 371 Date: Dec. 26, 2016

(30) Foreign Application Priority Data
Feb. 19, 2015 (TR) 2015/01987

(51) Int. Cl. A01N 25/24; A01N 31/16; A01N 55/02

(52) U.S. Cl. CPC A01N 25/24; A01N 55/02; A01N 31/16

(57) ABSTRACT

The present invention relates to a coating formulation which is developed for sterilization of annual and perennial plant seeds and agricultural implements. With the present invention; an antifungal, anticandidal, antibacterial and antiviral coating formulation containing zinc pyrithione, triclosan and carboxymethyl cellulose is obtained. Furthermore, thanks to the present invention, contaminations due to the areas of use of annual and perennial plant seeds and the silo, storehouse and warehouse surfaces, where the seeds are stored before seeding, can be prevented. The present invention can be used for sterilization of agricultural implements and equipment.

### CROSS REFERENCE TO RELATED APPLICATIONS

This application is the national phase entry of International Application No. PCT/TR2016/050035, filed on Feb. 10, 2016, which is based upon and claims priority to Turkish Patent Application No. 2015/01987, filed on Feb. 19, 2015, the entire contents of which are incorporated herein by reference.

### FIELD OF THE INVENTION

The present invention relates to a coating formulation which is developed for sterilization of annual and perennial plant seeds and agricultural implements.

### BACKGROUND OF THE INVENTION

The seed is the most important reproduction and propagation element used in plant production. It is reported that an estimate of 127,400,000 tons of seeds are used in the world in one year. Economic value of this amount is about 40-50 billion dollars. According to some estimates, commercial seed production is approximately 30 million dollars. Seed-borne pathogens are effective in different ways in plant production and may cause serious losses. It is known that seed-borne pathogens cause very important productivity and quality losses particularly in plant production. The pathogens causing diseases in plant production which are carried by seeds are called “Seed-borne pathogens”. All kinds of sterilization that will be performed for enhancing germination quality of the seeds used in agricultural areas and to reduce or completely eliminate the product losses occurring due to seed pathogens have a great importance.

Seed-borne fungal and bacterial diseases can cause serious problems for products that are obtained by both organic and conventional agricultural methods. Therefore, seed treatment (applying pesticide to the seeds) is performed in order to eliminate the potential harms of seed or soil-borne plant disease factors in agricultural production.

For this purpose, use of fungicides used in conventional agricultural applications for control of seed-borne fungal diseases is possible. Furthermore, it is stated in the study conducted by Kasselaki et al. in 2007 that several alternative improvement techniques were used in organic agriculture. However, the fact that the methods used today are partially effective on control of seed-borne bacterial pathogens is one of the most important problems we encounter in organic and conventional agriculture. Therefore developing new improvement methods for elimination of seed-borne pathogens is very important.

One of the periods that seed-borne pathogens cause serious problems is the seedling period. Contamination of the seeds with the pathogen microorganisms facilitates survival rate of the microorganisms and their propagation to new and large areas. In greenhouse conditions, serious economic loss risk arising from diseases of sensitive plants is very high because factors like high population, high relative humidity, high temperature and sprinkler irrigation play a supportive role in propagation of the plant diseases. Under these conditions, the most effective method of disease control is discarding. In this sense, pathogen scanning tests are carried out in seed lots and after eliminating the contaminated ones, the healthy seeds are used as seeding materials. Contamination and infestation are terms referring to a passive relationship between the pathogens and the seeds. As contamination of the pathogens to the seeds can be with the agronomic practices during production in the field, it can also occur during harvesting, blending, packaging, transporting or storage.

Contamination of the pathogens to the seeds is observed as adsorption bacterial cell, fungal spores (Clamidospores, Oospores, Teliospores, Uredospores) or virions to the seed during or after harvesting. The bacterial pathogens that can be carried in the seeds of some plants having economic importance and the induced diseases are given in Prior art Table 1. Fungal diseases and the fungi causing these diseases are given in Prior art Table 2.

Seed-borne bacterial pathogens cause symptoms such as decrease in product yield (15-30%); decrease or loss of germination ability of the seed; incidence of disease in the plant; color, form or biochemical changes and toxin formation in the seed, obstruction of seed formation or maturation; decay of the seeds; and wet rotting in the seeds.

There are approximately 11000 disease factors that produce bacteria, fungus and virus-induced infections in plants. About 13% loss of product yield around the world is caused by plant diseases. A large part of this loss is caused by virus-induced pathogens. The economic losses caused by pathogens in agricultural products vary from year to year, season to season, region to region, product to product. However according to the estimations, approximately 60 billion dollars' worth of product loss occurs every year to due to plant virus diseases. Prior art Table 3 gives the annual losses caused by some viruses in various plants.

PRIOR ART TABLE 1
The bacterial pathogens that can be carried in the seeds of some
plants having economic importance and the induced diseases

| | | Induced |
|---|---|---|
| Plant species | Pathogen | disease |
| Avena sativa | Pseudomonas syringae | Bacterial |
| (Oat) | pv. coronafaciens | blight |
| | P. s. pv. striafaciens | Bacterial |
| | | stripe |
| | | blight |
| Beta vulgaris | Curtobacterium flaccumfaciens | Bacterial |
| (Beet) | pv. betae | wilt |
| | P. s. pv. aptata | Bacterial |
| | | blight, |
| | | Leaf spot |
| Brassica spp. | P. s. pv. maculicola | Bacterial |
| (Cruciferae) | | leaf spot |
| | Pseudomonas spp., | Black rot |
| | Xanthomonas campestris | |
| | pv. campestris | |
| | X. c. pv. raphani | Bacterial |
| | | leaf spot |
| Capsicum spp. | Burkholderia solanacearum | Brown rot |
| (Pepper) | Erwinia spp., | Fruit |
| | Pseudomonas spp., | bacterial |
| | P. s. pv. tomato, | spot, branch |
| | X. vesicatoria | and leaf |
| | | blight |
| Cucumis sativus | P. s. pv. lachrymans | Angular leaf |
| (Cucumber) | | spot |
| | X. cucurbitae | Bacterial |
| | | leaf spot |
| Cucurbita spp. | X. cucurbitae | Bacterial |
| (Squash) | | leaf spot |
| Daucus carota | X. hortorum. pv. carotae | Bacterial |
| (Carrot) | | blight, |
| | | root scab |
| Glycine max | Bacillus subtilis, | Seedling |
| (Soya bean) | Burkholderia solanacearum, | wilt; |
| | Clavibacter spp | stunting |
| | Curtobacterium flaccumfaciens | Wilt |
| | P. savastanoi pv. glycinea | Bacterial |
| | | blight |
| | P. syringae pv. tabaci | Wild fire |
| | Pseudomonas spp., | Bacterial |
| | X. axonopodis pv. glycines | pustule |
| Gossypium spp. | X. a. pv. malvacearum | Black arm, |
| (Cotton) | | bacterial |
| | | blight |
| | | angular |
| | | leaf spot |
| Hordeum vulgare | P. s. pv. atrofaciens | Glume rot |
| (Barley) | | |
| | P. s. pv. syringae | Barley |
| | | kernel |
| | | blight |
| | X. translucens | Black chaff, |
| | pv. translucens | leaf blight |
| Lactuca sativa | Pseudomonas cichorii, | Leaf blight |
| (Lettuce) | X. a. pv. vitians | |
| Lycopersicon | Bacillus polymyxa, | Bacterial |
| esculentum | Burkholderia solanacearum, | cancer |
| (Tomato) | Clavibacter michiganensis | |
| | subsp. michiganensis | |
| | C. m. subsp. Sepedonicus | Potato |
| | | ring rot |
| | Pseudomonas corrugata | Necrosis |
| | P. s. pv. tomato | Bacterial |
| | | Leaf spot, |
| | | speckle |
| | X. vesicatoria | Bacterial |
| | | spot; |
| | | black spot |
| Nicotiana tabacum | E. carotovora | Philippines |
| (Tobacco) | subsp. carotovora, | leaf spot |
| | Pseudomonas aeruginosa | |
| | P. s. pv. mellea | Wisconsin |
| | | leaf spot |
| | P. s. pv. tabaci | Wild fire |
| | Rhodococcus fascians | Epinasty |
| | X. fragarie | Leaf spot |
| Oryza sativa | Burkholderia glumae, | Bacterial |
| (Rice) | Erwinia herbicola, | sheath rot |
| | Acidovorax avenae, | |
| | P. fuscovaginae | |
| | P. s. pv. syringae, | Bacterial |
| | X. oryzae pv. oryzae | leaf blight |
| | X. oryzae pv. oryzicola | Leaf stripe |
| | | blight |
| Phaseolus vulgaris | Clavibacter spp. | Brown chaff |
| (Bean) | Curtobacterium flaccumfaciens | Bacterial |
| | | wilt |
| | Enterobacter nimipressuralis, | Bacterial |
| | P. syringae pv. aceris, | brown spot |
| | P. syringae pv. syringae | |
| | P. savastanoi | Halo blight, |
| | pv. phaseolicola | greasy blotch |
| | P. viridiflava, | Bacterial |
| | X. a. pv. phaseoli | blight |
| | X. fragarie | Purple blotch |
| Medicago sativa | C. m. subsp. insidiosus | Bacterial |
| (Lucerne) | | wilt |
| | X. a. pv. alfalfae | Bacterial |
| | | leaf and |
| | | stem spot |
| Pisum sativum | P. savastanoi | Bacterial |
| (Pea) | pv. phaseolicola, | blight |
| | P. s. pv. pisi | |
| | X. fragarie | Purple spot |
| Prunus spp. | Agrobacterium tumefaciens, | |
| (Plum, apricot, | P. syringae | |
| cherry, peach) | | |
| Raphanus sativus | X. c. pv. raphani | |
| (Radish) | | |
| Secale cerale | X. translucens | Blackk chaff |
| (Rye) | pv. undulosa | |
| Sesamum indicum | P. s. pv. sesami | Bacterial |
| (Sesame) | | leaf spot |
| | X. c. pv. sesami | Bacterial |
| | | leaf spot |
| Solanum tuberosum | Erwinia spp. | |
| (Potato) | | |
| Trifolium spp. | Bacillus megaterium | |
| (Clover, | pv. ceralis, | |
| trifolium) | C. michiganensis | |
| | subsp. insidiosus, | |
| | Erwinia caratovora | |
| | subsp. caratovora, | |
| | Burkholderia solanacearum | |
| Triticum aestivum | Bacillus megaterium | White blotch |
| (Wheat) | pv. ceralis | |
| | Rathayibacter iranicus, | Yellow slime |
| | C. m. subsp. nebraskensis, | disease |
| | Rathayibacter tritici | |
| | Erwinia rhapontici | Pink seed |
| | P. syringae | Leaf necrosis |
| | P. s. pv. atrofaciens | Basal glume |
| | | rot, ear rot |
| | X. translucens | |
| | pv. translucens | |
| Zea mays (Corn) | C. michiganensis | Wilt |
| | subsp. nebraskensis | |
| | Erwinia chrysanthemi | Bacterial |
| | pv. zea, | wilt, leaf |
| | E. herbicola, | blight |
| | Pantoea stewartii | |
| | subsp. stewartii | |
| | P. syringae | Bacterial |
| | | spot, leaf |
| | | blight; |
| | | crown rot |
| | P. syringae pv. lapsa | |

PRIOR ART TABLE 2
Diseases caused by some fungi in plants

| Disease factor | Fungus species |
|---|---|
| Root and Root Collar | Fusarium spp., Rhizoctonia solani |
| Rots | |
| Leaf Spot | Alternaria alternata, A. brassicae, |
| | A. raphani |
| White Rot | Sclerotinia sclerotiorum |
| Early Blight Disease | Alternaria solani |
| Anthracnosis | Colletotrichum lindemuthianum |
| Late Blight | Phytophthora infestans |
| Loose Smut Disease | Ustilago nuda hordei, |
| | Ustilago nuda tritici |
| Bunt Disease | Tilletia foetida |
| Septoria Spot Disease | Septoria apiicola, |
| | Septoria lycopersici |

PRIOR ART TABLE 3
Annual losses caused by some viruses in some plants.

| Virus Species | Plant species | Region | Annual loss | |
|---|---|---|---|---|
| Tomato spotted wilt | All hosts | World | 1 · 10⁹ | $* |
| virus | | | | |
| Citrus tristeza virus | Citrus | World | 9-24 · 10⁶ | £** |
| | fruits | | | |
| Potato Y virus | Potato | UK | 30-50 · 10⁶ | £ |
| Potato X virus | | | | |
| Potato leafroll virus | | | | |
| Sugar beet yellow | Sugar beet | UK | 50 · 10⁶ | £ |
| mosaic virus | | | | |
| Barley yellow dwarf | Barley | UK | 6 · 10⁶ | £ |
| virus | | | | |
| Barley yellow dwarf | Wheat | UK | 5 · 10⁶ | £ |
| virus | | | | |
| Rice dwarf virus | Rice | Asia | 140 · 10⁶ | $ |

*$: Dollar;
**£: Pound Sterling

There are various studies in the state of the art about sterilization of seed surfaces. It is stated before in the literature that seed surfaces are sterilized with 1-5% sodium hypochlorite solution. However, in some studies, it was observed that Aspergillus spores could not be eliminated in seeds to which 1-5% sodium hypochlorite solution was applied.

Wilson, in his study conducted in 1915, stated that as a result of sterilization of 30 different seeds with calcium hypochlorite containing 2% chlorine, fungi were encountered only in three seeds and that calcium hypochlorite is suitable for use in seed sterilization.

Nega et al. (2003) tried to sterilize the seeds with warm water at different temperatures and periods of time in order to avoid exposure of the seeds that will be used in organic agriculture to chemical sterilization processes and succeeded in decreasing the number of pathogen microorganisms in the seed without losing the germination ability of the seeds. However, the pathogen microorganism on the seed cannot be completely eliminated either by this method. The microbial load can only be reduced by a certain ratio.

Seed improvement methods and compositions are developed in the patent documents no. WO 2012152737 and WO 2009021986 which are applications in the state of the art.

In the United States patent document no. US20130005811, a formulation that reduces the bacterial population located on the exterior surface of the seed coat. However it is not indicated that any of the said sterilization methods have any effect against bacteria, fungi, yeasts and viruses both in and out of the seed at the same time.

Japanese patent document no. JP2007209267, an application known in the art, relates to an antibacterial composition. The said application discloses a composition which enables to disinfect the seed coat.

The European patent document no. EP1865032, an application known in the art, discloses a pigment mixture that can be used on mica surfaces. This pigment can also be applied for obtaining antimicrobial surface in seed coat by using zinc oxide and derivatives thereof.

### SUMMARY OF THE INVENTION

The objective of the present invention is to provide an antifungal coating formulation containing zinc pyrithione, triclosan and carboxymethyl cellulose.

Another objective of the present invention is to provide an anticandidal coating formulation containing zinc pyrithione, triclosan and carboxymethyl cellulose.

A further objective of the present invention is to provide an antibacterial coating formulation containing zinc pyrithione, triclosan and carboxymethyl cellulose.

Another objective of the present invention is to provide an antiviral coating formulation containing zinc pyrithione, triclosan and carboxymethyl cellulose.

A further objective of the present invention is to provide a coating formulation which can be applied to seeds of annual and perennial plants.

Another objective of the present invention is to provide a coating formulation which enhances germination ability of the seeds by preventing growth of microorganisms.

A further objective of the present invention is to provide a coating formulation which reduces or eliminates the product losses as a result of infection occurring in the seeds of annual and perennial plants.

Another objective of the present invention is to provide a coating formulation for sterilization of surfaces where there is fungal, bacterial and viral contamination due to the areas of use of the annual and perennial plant seeds and the surfaces of silos, storehouses and warehouses where the seeds are stored before seeding.

Another objective of the present invention is to provide a coating formulation which can be used for sterilization of agricultural implements and equipment.

A further objective of the present invention is to provide an antimicrobial product obtained by the formulation of the invention.

### BRIEF DESCRIPTION OF THE DRAWINGS

FIG. 1 is the view of the antibacterial activity of the coating product containing ZTC on the bacteria Clavibacter michiganensis.

FIG. 2 is the view of the antifungal activity of the coating product containing ZTC on the fungus Botrytis spp.

FIG. 3 is the view of the antifungal activity of the coating product containing ZTC on the fungus Fusarium spp.

FIG. 4 is the view of the antibacterial activity of the coating product containing ZTC on the bacteria Pseudomonas syringae on safflower seed and the safflower seed on which nothing is applied.

FIG. 5 is the view of germination of corn seeds on which the coating product containing ZTC is applied.

FIG. 6 is the view of the corn seeds on which coating is not performed.

FIG. 7 is the view of germination of sunflower seeds on which the coating product containing ZTC is applied.

FIG. 8 is the view of the sunflower seeds on which coating is not performed.

FIG. 9 is the view of germination of wheat seeds on which the coating product containing ZTC is applied.

FIG. 10 is the view of the wheat seeds on which coating is not performed.

### DETAILED DESCRIPTION OF THE INVENTION

A seed coating formulation is developed with the present invention which is effective against all kinds of pathological factors (bacteria, fungi and viruses) that are present both on the surface and inside the seeds and which does not harm germination ability of the seed. This coating formulation exhibits sterilized effect on all kinds of seeds. If the said formulation is used, seed-borne diseases will be controlled and also soil-borne pathogen losses will be reduced. The developed product exhibits the same antimicrobial and antiviral activity on not one but all seed species.

The process of developing seed coating formulation containing zinc pyrithione (C₁₀H₈N₂O₂S₂Zn), triclosan (C₁₂H₇Cl₃O₂) and carboxymethyl cellulose for surface sterilization is performed as described below.
5 g carboxymethyl cellulose is mixed within 964.16 g water at 50° C. until it becomes completely homogenous and viscous to obtain 1000 g solution. Then, 0.5 g triclosan and 20.83 g zinc pyrithione is added therein. The obtained mixture is stirred for about 30 minutes. As a final ratio, 0.01-0.1% by volume of triclosan and 0.5-2% by volume of zinc pyrithione are obtained. This prepared formulation is used for coating the seed surface after it cools to room temperature. The said formulation containing zinc pyrithione, triclosan and carboxymethyl cellulose is hereinafter referred to as “ZTC” (abbreviation).

The process of coating the seeds with the formulation is carried out as follows;
In order to carry out the process of coating the seed with the solution at room temperature (25° C.), first the solution and then the seeds are placed in flacons. Coating process is carried out at room temperature of 25-30° C. for 15 minutes at 12 rpm for the solution in the flacons to completely coat the surface of the seeds. In the last step which enables to provide antimicrobial property to the seeds, the seeds are filtered and then dried at 25-30° C. in a drying oven.

The same formulation can be applied on agricultural implements and storage surfaces by immersion or spraying such that it will coat the entire surface.

The product obtained with the coating formulation sterilizes the seed surfaces, agricultural implements and storage surfaces by coating them.

The “Coating formulation for seed and surface sterilization” developed to fulfill the objective of the present invention is illustrated in the accompanying figures.

### Experimental Studies

Antimicrobial Tests

The antimicrobial seed coating formulation of the present invention was applied to the seeds by means of the below described coating method. Equal amounts of coated seeds and untreated seeds were placed on Nutrient Agar (NA), Sabouraud Dextrose Agar (SDA) and Potato Dextrose Agar (PDA) respectively in order to observe microorganism growth on the seed surface. The petri dishes, which contained media suitable for bacteria, yeast and fungus growth, were kept at 25±1° C. for bacteria for 24 hours and at 36±1° C. for yeasts for 48 hours and at 25±1° C. for fungi for 72 hours. Untreated seeds were used as negative control. Antimicrobial activity of the antimicrobial seed coating formulation on the seed was evaluated by taking into to consideration the microorganisms growing around the seed. Antimicrobial activity test results of the seeds coated with the tested antimicrobial seed coating product containing zinc pyrithione, triclosan and carboxymethyl cellulose are summarized in Prior art Table 1. All tests were repeated at least twice.

Antimicrobial activity tests of the coated seeds;

Antimicrobial activity tests of the plant seeds, which were prepared with the formulation containing ZTC as described above, were carried out simultaneously with two different methods. In the first test method; isolates from the bacteria Pseudomonas syringae, Clavibacter spp., Burkholderia spp., Curtobacterium spp., Bacillus spp., Peudomonasaeruginosa, Erwinia spp., Xanthomnonasaxonopodis, Xanthomonascampestris and Agrobacterium spp; the yeast Candida spp. and the fungi Aspergillus spp., Botrytis cinerea, Fusarium spp., Penicillium spp., Rhizopus spp., Alternaria spp., Rhizoctonia spp. and Sclerotinia spp. were inoculated on petri dishes containing suitable media (NA, SDA and PDA respectively). Seeds coated with ZTC-containing formulation were placed on the inoculated petri dishes. The inoculated petri dishes were incubated for 24 hours for bacteria and 48 hours for yeasts at 36±1° C. and 72 hours for fungi at 25±1° C. Antimicrobial activities of the seeds were assessed by observing the inhibition zone (zone where microorganisms do not grow) formed around the samples on which application is made.

In the second method, the seeds coated with ZTC-containing formulation were crushed by using a mortar and pestle in order to observe the effect of the formulation on the endophytic microorganism load in the seeds. The crushed seeds were incubated in Nutrient Broth (NB) and Sabouraud Dextrose Broth (SDB) media respectively. The samples, which were agitated at 25±1° ° C. for one hour at 100 rpm, were added into Nutrient Agar (NA), Sabouraud Dextrose Agar (SDA) and Potato Dextrose Agar (PDA), respectively, by means of a micropipette such that there will be 100 μl in each medium and were inoculated with diffusion method by the help of drigalski. The inoculated samples were incubated for 24 hours for bacteria and 48 hours for yeasts at 36±1° C. and 72 hours for fungi at 25±1° C. and the effect of the formulation on the endophytic microorganism load in the seeds was observed by examining the microorganism growth.

Germination Tests of Coated and Uncoated Seeds

The seeds coated with the formulation containing zinc pyrithione, triclosan and carboxymethyl cellulose and the seeds which are not treated in any way as control group were placed on NA and PDA media. Germination ratio of the seeds in the petri dishes which were taken into a germination cabin to provide a suitable environment for germination and the effect of the contamination in the media on the germination of the seeds were observed at certain intervals.

Antiviral Tests

Antiviral Activity Tests of Zinc Pyrithione;

In order to produce Human adenovirus type 5 Adenoid 75 strain and Poliovirus type 1 Chat strain virus and to carry out the experiment, a complete layer of HEp-2 cells (ATCC CCL-23), which are human monolayer tumor cells, were used. For determining virus titration, reference Human adenovirus type 5 Adenoid 75 strain and Poliovirus type 1 Chat strain were inoculated by making serial dilutions to HEp-2 cells, and by taking as basis the virus dilution that produces a cytopathic effect visible in invert microscope, virus titration was computed by using Spearman-Karber method. These viruses were tested as model DNA and RNA viruses. The formulations effective against these viruses are accepted to be effective against other plant and human pathogen viruses. In order to determine Sub-Cytotoxic concentration of Zinc pyrithione, liquid zinc pyrithione was 10-fold serially diluted with Eagle's minimum essential medium (MEM) and non-toxic concentration was detected in the cell medium and this concentration was used in the experiment. For the controls, MEM inoculated HEp-2 cells, full layer HEp-2 cells wherein zinc pyrithione was not added, 10-fold diluted reference virus titration control, formaldehyde control and controls containing toxic concentrations of zinc pyrithione were used as negative control instead of the virus.

Preparation of Cell Culture Medium and the Chemicals

MEM medium: 10% serum (FBS) containing enzymes, hormones and growth factors for the cells to adsorb to the surfaces and proliferate; and 40 IU/ml penicillin, 0.04 mg/ml streptomycin, 0.5 mg/ml glutamine to prevent fungi and bacteria contamination; and 1% sodium bicarbonate as a buffer solution were added therein.

FBS: Inactivated and Mycoplasma-Free

Sodium bicarbonate: Sterile 7.5% solution

Medium Used in Virus Inoculation:

The medium included 1% antibiotic (Penicillin, Streptomycine, Amphotericin B) in order to prevent fungi and bacteria contamination, and 1% sodium bicarbonate as a buffer solution. FBS serum was not added to this medium.

Preparation of Clean and Polluted Media Clean medium; 0.3 gr Bovine Serum Albumin Fraction V is dissolved in 100 ml sterile water. The solution that was obtained was sterilized by being passed through a filter with mesh size 0.22 μM.

Polluted medium; sheep erythrocyte and BSA are used for the polluted medium. 3 g BSA is dissolved in 100 ml sterile water and filtered. 3 ml sheep erythrocyte was completed to 97 ml BSA.

Erythrocyte; 8 ml fresh sheep blood was rotated at 800 G for 10 minutes and then its supernatant was removed. Upon adding 8 ml phosphate buffer salt (PBS) thereon, pipetting was performed and it was again rotated at 800 G for 10 minutes. This procedure was repeated three times.

Analysis

Firstly, liquid zinc pyrithione was solid serially diluted with the cell culture medium (MEM) and its non-toxic concentration in cell culture was calculated. 8 ml of the zinc pyrithione that was to be tested was mixed with 2 ml hard water. The obtained solution was serially diluted (dilution step 1:10) with MEM. After it was incubated in 96-well monolayered cells, the microscopic changes that occurred were recorded. Concentrations that showed cytopathic effect (CPE) were determined. Zinc pyrithione and formaldehyde CPE values were compared. After determining non-toxic concentration of zinc pyrithione on the cells, the effects of zinc pyrithione on virus titration as a result of 1-60 minutes application periods in clean and polluted media were studied. For the controls, MEM inoculated HEp-2 cells, full layer HEp-2 cells wherein zinc pyrithione was not added, 10-fold diluted reference virus titration control, formaldehyde control and controls containing toxic concentrations of zinc pyrithione were used as negative control instead of the virus. Taking as basis the virus dilutions wherein cytopathic effect that is visible in invert microscope is formed, virus titration was calculated as TCID₅₀ value by using Spearman-Karber method. According to TS EN 14476 (MARCH 2007) standard, disinfectants should reduce virus titration by 4 or more logs for their antiviral activities.

### Experimental Results

The formulation containing zinc pyrithione, triclosan and carboxymethyl cellulose was applied to the seeds in in vitro conditions. According to the antimicrobial activity test conducted, it was observed that the seed coatings made with the formulation containing zinc pyrithione, triclosan and carboxymethyl cellulose had an effect of preventing growth of all of the tested microorganisms (bacteria, yeasts and fungi) (Table 1).

TABLE 1
Antimicrobial activity of the formulation containing zinc pyrithione,
triclosan and carboxymethyl cellulose on the tested microorganisms

formulation containing zinc
pyrithione, triclosan and
carboxymethyl cellulose

BACTERIA

| | |
|---|---|
| Pseudomonas syringae | +^{a} |
| Clavibacter spp. | + |
| Burkholderiaspp. | + |
| Curtobacteriumspp. | + |
| Bacillus spp. | |
| Pseudomonas aeruginosa | + |
| Erwinia spp. | + |
| Xanthomonas axonopodis | + |
| Xanthomonas campestris | + |
| Enterobacter spp. | + |
| Agrobacteriumspp. | + |

YEAST

| | |
|---|---|
| Candida spp. | + |

FUNGI

| | |
|---|---|
| Aspergillus spp. | + |
| Fusarium spp. | + |
| Botrytis spp. | + |
| Penicillium spp. | + |
| Alternaria spp. | + |
| Rhizoctonia spp. | + |
| Rhizopus spp. | + |
| Sclerotinia spp. | + |

^{a}+ sign indicates that the formulation applied had antimicrobial activity.

Antimicrobial activities in the prepared seeds were tested by using isolates from the bacteria (Pseudomonas syringae, Clavibacter spp., Burkholderia spp., Curtobacterium spp., Bacillus spp., Pseudomonasaeruginosa, Erwinia spp., Xanthomonasaxonopodis, Xanthomonascampestris and Agrobacterium spp); the yeast (Candida spp.); and the fungi (Aspergillus spp., Botrytis cinerea, Fusarium spp., Penicillium spp., Rhizopus spp., Alternaria spp., Rhizoctonia spp. and Sclerotinia spp.). According to the obtained results, it was observed that the seeds on which antimicrobial seed coating formulation containing zinc pyrithione, triclosan and carboxymethyl cellulose was applied had antimicrobial activity on all of the tested microorganisms (Table 2, 3, 4). Furthermore, the invention has antiviral activity on all kinds of DNA and RNA viruses causing diseases in plants.

TABLE 2
Antimicrobial activity test results of the seeds
coated with the formulation containing zinc pyrithione,
triclosan and carboxymethyl cellulose

| | | Bacteria | | | | |
|---|---|---|---|---|---|---|
| | | | | Burk- | Curto- | |
| | For- | P. | Clavibacter | holderia | bacterium | Bacillus |
| Seeds | mulas | syringae | spp. | spp. | spp. | spp. |
| Wheat | ZTC^{a} | +^{c} | + | + | + | + |
| | N.K.^{b} | −^{d} | − | − | − | − |
| Barley | ZTC | + | + | + | + | + |
| | N.K. | − | − | − | − | − |
| Sugar | ZTC | + | + | + | + | + |
| Beet | N.K. | − | − | − | − | − |
| Corn | ZTC | + | + | + | + | + |
| | N.K. | − | − | − | − | − |
| To- | ZTC | + | + | + | + | + |
| bacco | N.K. | − | − | − | − | − |
| Rice | ZTC | + | + | + | + | + |
| | N.K, | − | − | − | − | − |
| Bean | ZTC | + | + | + | + | + |
| | N.K. | − | − | − | − | − |
| Tomato | ZTC | + | + | + | + | + |
| | N.K. | − | − | − | − | − |
| Sun- | ZTC | + | + | + | + | + |
| flower | N.K. | − | − | − | − | − |

^{a}ZTC: the formulation containing zinc pyrithione, triclosan and carboxymethyl cellulose applied to the seeds.
^{b}N.K.: Distilled water applied to the seeds.
^{c}+ sign indicates that the formulation applied had antimicrobial activity.
^{d}− sign indicates that the formulation applied did not have antimicrobial activity.

TABLE 3
Antimicrobial activity test results of the seeds
coated with the formulation containing zinc pyrithione,
triclosan and carboxymethyl cellulose

| | | Bacteria | | | | Yeasts |
|---|---|---|---|---|---|---|
| | | | | | Agro- | Can- |
| | For- | Erwinia | X. | X. | bacterium | dida |
| Seeds | mulas | spp. | axonopodis | campestris | spp. | spp. |
| Wheat | ZTC^{a} | + | + | + | + | + |
| | N.K.^{b} | − | − | − | − | − |
| Barley | ZTC | + | + | + | + | + |
| | N.K. | − | − | − | − | − |
| Sugar | ZTC | + | + | + | + | + |
| beet | N.K. | − | − | − | − | − |
| Corn | ZTC | + | + | + | + | + |
| | N.K. | − | − | − | − | − |
| To- | ZTC | + | + | + | + | + |
| bacco | N.K. | − | − | − | − | − |
| Rice | ZTC | + | + | + | + | + |
| | N.K. | − | − | − | − | − |
| Bean | ZTC | + | + | + | + | + |
| | N.K. | − | − | − | − | − |
| Tomato | ZTC | + | + | + | + | + |
| | N.K. | − | − | − | − | − |
| Sun- | ZTC | + | + | + | + | + |
| flower | N.K. | − | − | − | − | − |

^{a}ZTC: the formulation containing zinc pyrithione, triclosan and carboxymethyl cellulose applied to the seeds.
^{b}N.K.: Distilled water applied to the seeds.
c. + sign indicates that the formulation applied had antimicrobial activity.
d. − sign indicates that the formulation applied did not have antimicrobial activity.

TABLE 4
Antimicrobial activity test results of the seeds
coated with the formulation containing zinc pyrithione,
triclosan and carboxymethyl cellulose

| | | Fungi | | | | | | |
|---|---|---|---|---|---|---|---|---|
| | | | | Peni- | | | | |
| | | Asper- | Fusar- | cil- | Alter- | Rhizoc- | Rhi- | Scler- |
| | For- | gillus | ium | lium | naria | tonia | zopus | otinia |
| Seeds | mulas | spp. | spp. | spp. | spp. | spp. | spp. | spp. |
| Wheat | ZTC^{a} | +^{c} | + | + | + | + | + | + |
| | N.K.^{b} | −^{d} | − | − | − | − | − | − |
| Barley | ZTC | + | + | + | + | + | + | + |
| | N.K. | − | − | − | − | − | − | − |
| Sugar | ZTC | + | + | + | + | + | + | + |
| beet | N.K. | − | − | − | − | − | − | − |
| Corn | ZTC | + | + | + | + | + | + | + |
| | N.K. | − | − | − | − | − | − | − |
| To- | ZTC | + | + | + | + | + | + | + |
| bacco | N.K. | − | − | − | − | − | − | − |
| Rice | ZTC | + | + | + | + | + | + | + |
| | N.K. | − | − | − | − | − | − | − |
| Bean | ZTC | + | + | + | + | + | + | + |
| | N.K. | − | − | − | − | − | − | − |
| Tomato | ZTC | + | + | + | + | + | + | + |
| | N.K. | − | − | − | − | − | − | − |
| Sun- | ZTC | + | + | + | + | + | + | + |
| flower | N.K. | − | − | − | − | − | − | − |

^{a}ZTC: the formulation containing zinc pyrithione, triclosan and carboxymethyl cellulose applied to the seeds.
^{b}N.K.: Distilled water applied to the seeds.
^{c}+ sign indicates that the formulation applied had antimicrobial activity.
^{d}− sign indicates that the formulation applied did not have antimicrobial activity.

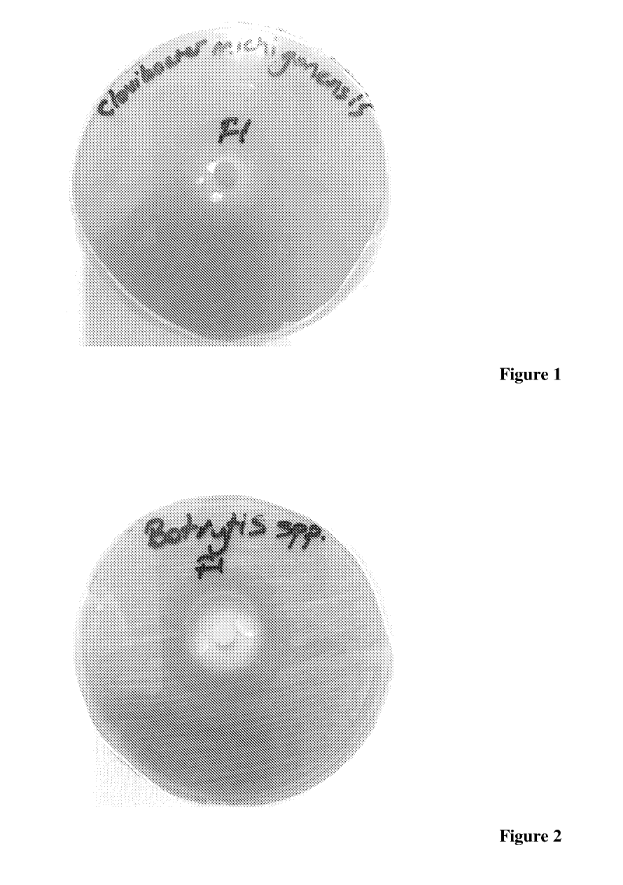

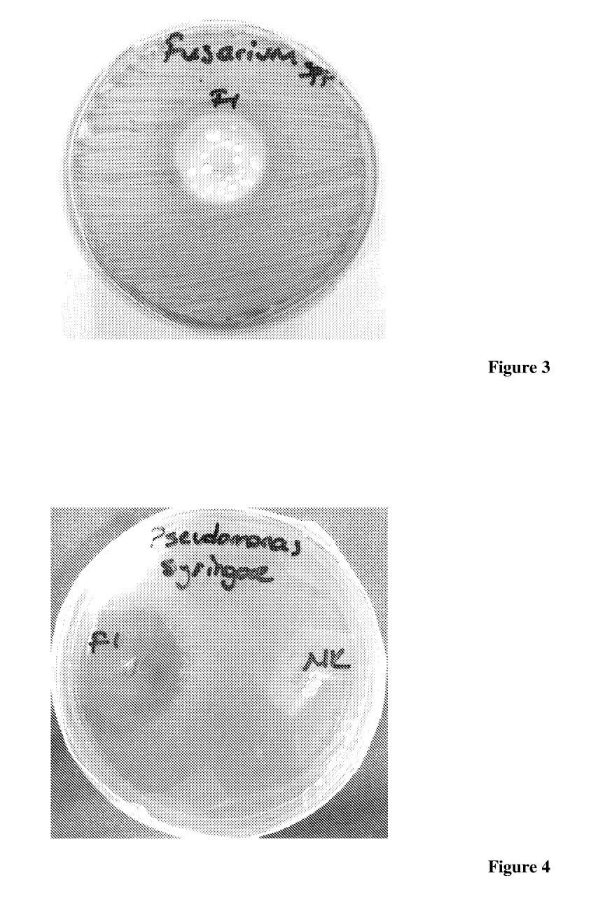

As a result of the experimental studies, it was observed that the antimicrobial seed coating product containing zinc pyrithione, triclosan and carboxymethyl cellulose has antimicrobial activity on microorganisms (FIG. 1, FIG. 2, FIG. 3).

While no microbial contamination was observed in the seeds treated with the antimicrobial seed coating product containing zinc pyrithione, triclosan and carboxymethyl cellulose; it was determined that the untreated seeds were exposed to microbial contamination (FIG. 4).

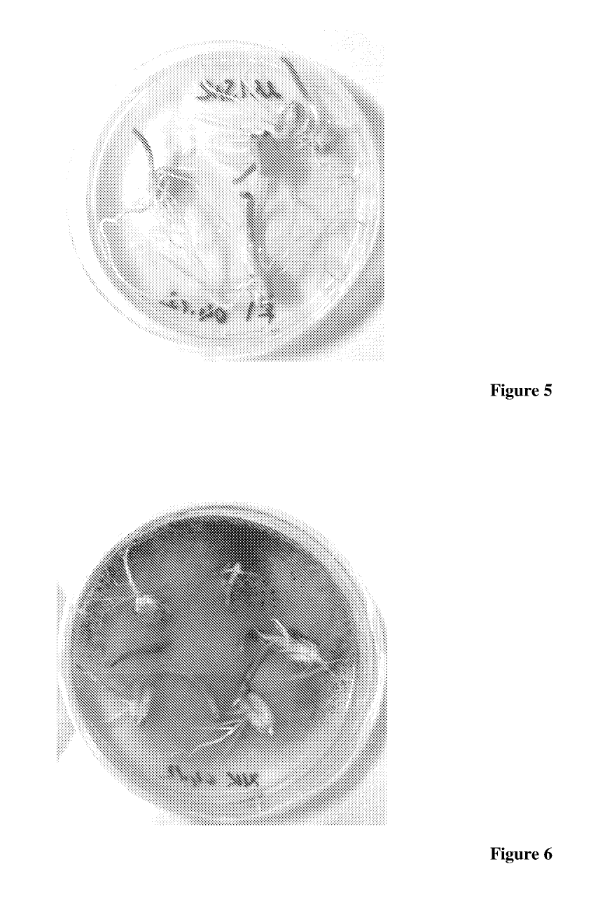

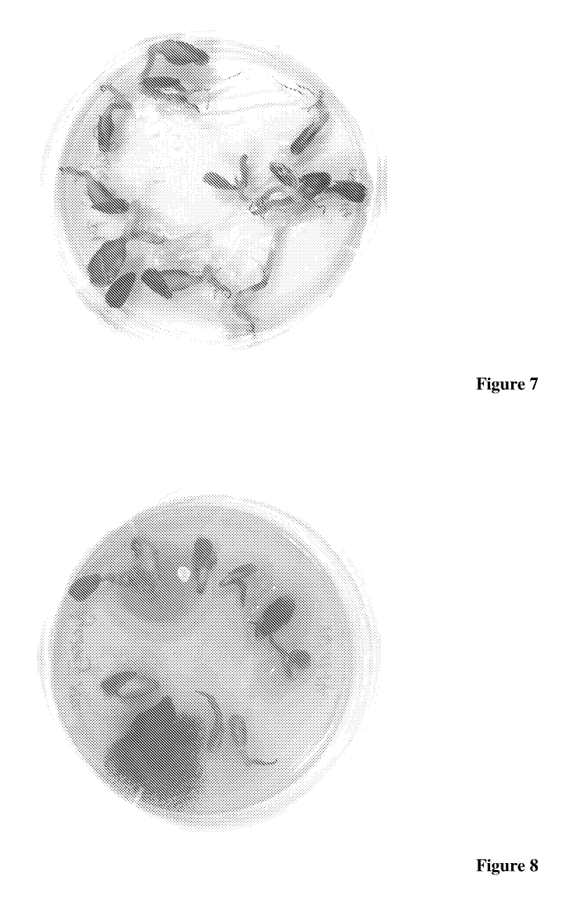

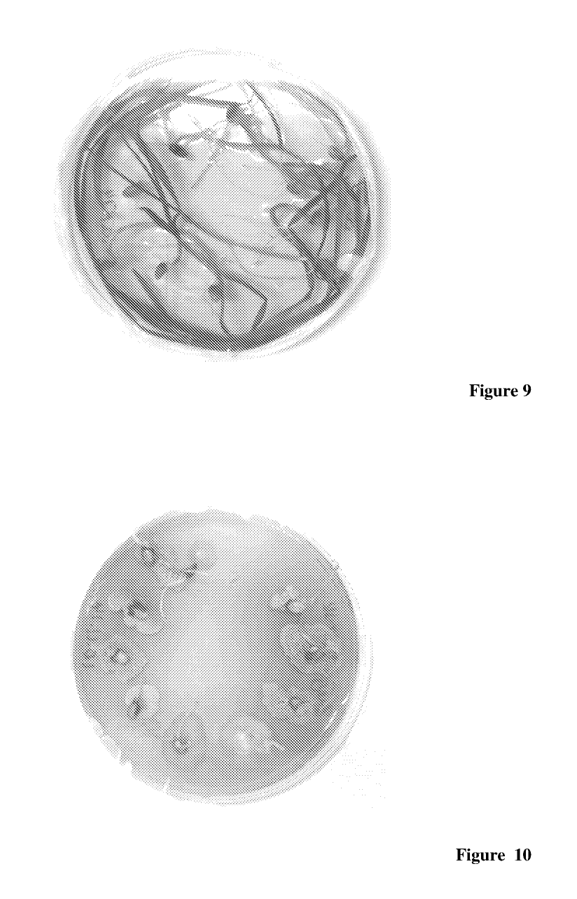

While no contamination was observed in the media where the seeds treated with the antimicrobial seed coating product containing zinc pyrithione, triclosan and carboxymethyl cellulose were placed (FIG. 5, FIG. 7, FIG. 9); it was determined that germination ratio of the seeds were higher than the negative controls (FIG. 6, FIG. 8, FIG. 10).

Since the 10%, 1% and 0.1% suspensions of the tested zinc pyrithione showed cytopathic effect on the cells in the cell culture, the lowest ratio of the said zinc pyrithione solution which does not show cytopathic effect, i.e. 0.01%, was used.

It was observed in the calculations made as a result of the test that zinc pyrithione caused at least 4 log reduction in virus titration at all experiment conditions (Table 5 and Table 6) as a result of application at a ratio of 1/1, at room temperature (20° C.), in clean and polluted media and within 1 and 60 minute application periods. According to Antimicrobial Division US EPA standards, disinfectants should reduce virus titration by 4 or more logs for their virucidal activities.

TABLE 5
Antiviral activity of zinc pyrithione in HEp-2 cell culture
against Human adenovirus type 5 virus Adenoid 75 strain

| | | Zinc pyrithione | | | |
|---|---|---|---|---|---|
| | Reference | 1 minute | | 60 minutes | |
| Virus | virus | Clean | | Clean | Polluted |
| titration* | 5.3 | medium | Polluted | medium | medium |

| | | | | |
|---|---|---|---|---|
| Virus titration with | 1.0 | 1.0 | 1.0 | 1.0 |
| disinfectant** | | | | |
| Reduction ratio in | 4.0 | 4.0 | 4.0 | 4.0 |
| virus titration*** | | | | |

*Logarithmic TCID₅₀ value of the virus in ml.
**Logarithmic TCID₅₀ value of the virus treated with the disinfectant at different periods and media.
***Logarithmic TCID₅₀ ratio between the virus titration and the virus titration with disinfectant

TABLE 6
Antiviral activity of Zinc pyrithione in HEp-2 cell
culture against Poliovirus Type I virus Chat strain

| | | Zinc pyrithione | | | |
|---|---|---|---|---|---|
| | Reference | 1 minute | | 60 minutes | |
| Virus | virus | Clean | Polluted | Clean | |
| titration* | 5.5 | medium | medium | medium | Polluted |

| | | | | |
|---|---|---|---|---|
| Virus titration with | 1.5 | 1.0 | 1.5 | 1.5 |
| disinfectant** | | | | |
| Reduction ratio in | 4.0 | 4.5 | 4.0 | 4.0 |
| virus titration*** | | | | |

*Logarithmic TCID₅₀ value of the virus in ml
**Logarithmic TCID₅₀ value of the virus treated with the disinfectant at different periods and media.
***Logarithmic TCID₅₀ ratio between the virus titration and the virus titration with disinfectant

As a conclusion; these experiment results show that Zinc pyrithione is 99.9% active against Human adenovirus type 5 virus and 99.9% active against Poliovirus Type 1 virus when used directly without being diluted at room temperature (20° C.) within 1 and 60 minute application periods.

In accordance with the TS EN 14476 (March 2007) standards of Turkish Standards Institute (TSE), it is accepted that this product, whose virucidal activity against Human adenovirus type 5 which is a DNA model virus sample is researched, shows the same virucidal activity against the other enveloped or non-enveloped DNA viruses which cannot be practically tested in laboratory such as HBV provided that it is used at least at the above mentioned solubility and periods and against other plant pathogen viruses if used with any one of the methods of washing, wiping, impregnation (wetting/immersing). Furthermore, it is accepted that this product, whose virucidal activity against Poliovirus Type 1 which is an RNA model virus sample is researched, shows the same virucidal activity against other enveloped or non-enveloped RNA viruses which cannot be practically tested in laboratory such as HCV and HIV provided that it is used at least at the above mentioned solubility and periods.

The present invention is not limited to the seeds given above and can be applied to all annual and perennial plant seeds.

The seed coating formulation of the present invention also eliminates the contaminations encountered during agronomic practices such as grafting, pruning and hoeing used in plant production, and can be used for sterilization of agriculture implements.

This formulation can also be used as a protective agent or an additive in coating products for preventing biological degradation and deterioration occurring as a result of bacterial or fungal contaminations on wooden surfaces.

The content of the formulation of the present invention can be brought into a product form with different materials.

1. A coating formulation comprising zinc pyrithione, triclosan and carboxymethyl cellulose, wherein the coating formulation exhibits antiviral, antifungal, antibacterial, anticandidal activity in plant seeds.

2. The coating formulation according to claim 1, wherein the zinc pyrithione is 0.5-2% by mass.

3. The coating formulation according to claim 2, wherein the triclosan is 0.01-0.1% by mass.

4. The coating formulation according to claim 3, which shows activity against the bacteria Pseudomonas syringae, Clavibacter spp., Burkholderia spp., Curtobacterium spp., Acinetobacterbaumannii, Bacillus spp., Pseudomonasaeruginosa, Erwinia spp., Xanthomnonasaxonopodis, Xanthomonascampestris, and Agrobacterium spp.

5. The coating formulation according to claim 3, which shows activity against the yeast Candida spp.

6. The coating formulation according to claim 3, which shows activity against the fungi Aspergillus spp., Botrytis spp., Fusarium spp., Penicillium spp., Rhizopus spp., Alternaria spp., Rhizoctonia spp. and Sclerotinia spp.

7. The coating formulation according to claim 3, which shows activity against the DNA and RNA viruses causing diseases in plants.

8. The coating formulation according to claim 3, which can be applied to annual and perennial plant seeds.

9. (canceled)

10. (canceled)
